(19) United States
(12) Patent Application Publication
(10) Pub. No.: US 2007/0144322 A1
(43) Pub. Date: Jun. 28, 2007

(54) Method and apparatus for cutting parabolic shaped segments on a corrugating machine

(76) Inventor: William Paul Niedermeyer, Green Bay, WI (US)

Correspondence Address: WILLIAM P. NIEDERMEYER, 1024 MT MARY DRIVE, GREEN BAY, WI, 54311, US

(21) Appl. No.: 11/318,979

(22) Filed: Dec. 27, 2005

(51) Int. Cl. B26D 3/00; B26D 7/06

(52) U.S. Cl. 83/53; 83/98; 83/177

(57) ABSTRACT

Method and apparatus for water jet cutting parabolic shaped segments that support reflective surfaces of a concentrating solar collectors. Apparatus describes corrugating machine cutoff, parabolic curve water jet cutters longitudinal slitters, transfer/diverters, and stackers. Parabolic curve cutting involves at least one cutter on a first transverse path with means for reversing movement over a moving web in cooperation with a cutter on a parallel second path with means for mirror image movement to make a pair of opposite curves which intersect at segment ends. Jet cutter reversing servo motor drive means programmable for different parabolic curves. Includes use of plurality of cutter pairs to make segments with multiple parabolic curves per length. Apparatus includes means to make standard corrugated board or parabolic segments by electronic switching without machine adjustments.

### BACKGROUND AND SUMMARY OF THE INVENTION

Because solar radiation emits low levels of energy, very large areas are required for collection and concentration. The instant invention involves high speed production of corrugated paperboard parabolic segments as supports for a reflective surface in a concentrating trough collector.

Numerous corrugating machines worldwide can be adapted to produce parabolic segments in addition to regular corrugated board segments for cartons.

Stationary water jet cutters made by Flow Industries Inc of Kent Wash. and Ingersoll Rand are well known and used extensively to slit full width webs into a plurality of narrower webs at speeds over 350 ft/min with linear cuts from high pressure water jet cutters.

Co-invented prior art U.S. Pat. Nos. 4,190,037 and 4,260,112 (1980-1) included a movable upper framework with attached water jets for cutting a fixed length parabolic curves required two machine slots for longitudinally spaced cutters mounted on the framework above the web, did not describe use of a lower oscillating frame to mount jet stream receivers (enegy dissipaters), and with a fixed length frame was limited to producing only one length of intersecting parabolic curves without means for adjustment.

The instant invention covers a full range of parabolic apertures up to about 12 ft., and requires only one slot or space for two reversing programmable water jet cutters moving above and receivers moving below the moving web.

In addition, the instant apparatus can produce segments having a plurality of parabolic curved surfaces, has low mass and inertia forces, is programmable for parabolic length and cutter movement using servo motors and digital software not available twenty five years ago.

The instant invention includes two movable water jet cutters, each attached to a parallel spaced apart transversely oriented belt path, with belts driven by reversible servo motors following digital commands from a computer programmed for parabolic curves.

The first path cutter generates an oscillating parabolic cut symmetrically about a longitudinal axis and crosses the axis coincident with both ends of the transversely cut segment.

The second path cutter generates an oscillating mirror image cut symmetrically about the same longitudinal axis and crosses the axis at segment ends as it intersects the first parabolic cut. This interaction produces two opposing segments for each slit web, each segment with parabolic inside surfaces.

Adding a second cutter to each belt drive replicates the intersecting parabolic cuts in a second adjacent slit web and produces a second pair of segments

This invention also describes segments each having a plurality of parabolic cut surfaces per segment length and apparatus for making multiple segments from a plurality of parallel slit webs with water jet cutter drive means responsive to programmable commands based on parabolic apertures, focal points segment height and web slit width compatible with the corrugating machine width.

For example, a 90″ wide corrugator will produce four segments from two 45″ slit webs. With an aperture of 7.5 ft and cut at web speed of 350 fpm, total machine output of 24 million segments annually is enough to make collectors with a total solar collector area of 150 million sq. ft.

The instant apparatus includes an existing machine cutoff section, and successive sections for the dual parabolic cutters, a fixed plurality of jet cutters for longitudinal slits, transfer & diverting, and alternating stacker sections.

### BRIEF DESCRIPTION OF THE DRAWINGS

FIG. 1 is a diagrammatic plan view of apparatus sections illustrating the rotary cutoff unit of the corrugating machine, a section with dual water jet cutters for reversing movement along parallel belt paths, a plurality of fixed jet cutters, a transfer section and two stacker sections with various cut components crosshatched for identification. Serial parabolic and slit cuts are shown.

FIG. 2 is a diagrammatic plan view similar to FIG. 1 illustrating selected sections with the parabolic cut describing a resultant pair of segments having a larger aperture.

FIG. 3 is a diagrammatic plan view similar to FIG. 1 illustrating selected sections with smaller parabolic cuts describing a segment with a plurality of parabolic surfaces on one edge. Selected segments are crosshatched.

FIG. 4 is an enlarged schematic plan view of the parabolic cutting section illustrating two spaced apart jet cutters supported in slideable holders attached to belts driven by reversing programmable motors. Water jet stream receivers mounted directly below are obscured from view (See FIGS. 5, 6).

FIG. 5 is a schematic end elevation of the traversing cutters viewed along line 5-5 of FIG. 4 illustrating programmable servo motor drives on opposite ends. The upper motor drives the jet nozzle and the lower motor drives the jet stream receiver directly below in synchronism with the nozzle.

FIG. 6 is a schematic side elevation viewed from 6-6 of FIG. 5 illustrating an upper jet cutter and lower receiver supported on cross rails and moveable on parallel adjacent paths. Servo motors for the second path are dashed for clarity.

FIG. 7 is a schematic plan view of fixed jet cutters mounted above the moving web illustrating edge trim and intermediate longitudinal cuts that form and portions at the top ends of the parabolic shaped segments. Jet receiver tubes directly below the web are obscured from view (see FIGS. 8, 9)

FIG. 8 is a schematic end elevation viewed in the direction of web travel along line 8-8 of FIG. 7 illustrating the edge and intermediate cut positions.

FIG. 9 is a schematic side elevation of the stationary jet cutters and receivers viewed from 9-9 of FIG. 8.

FIG. 10 is an enlarged schematic plan view from 10-10 of FIG. 11 illustrating the transfer and central trim diverting section, and two successive sections for alternate stacking operation and discharge in both side directions.

FIG. 11 is a simplified side elevation schematic of the instant apparatus Illustrating the corrugating machine rotary cutoff section, water jet parabolic curve cutting section, jet trim cutter section, transfer and trim diverter section with vacuum bypass belts and two spaced stacker sections with programmable motor and drive system for movable platform from an upper loading position to a lower discharge position below the top of the stack support rails.

FIG. 12 is a plan view schematic of a stacker section with overhead vacuum belts removed as viewed from 12-12 of FIG. 11 and with the bottom segment removed illustrating the vertically movable platform slots and the spaced fixed rails to support a completed stack.(shown crosshatched for clarity). Transverse movable stack ejector arms are shown under complated stacks shown transferred to additional rails on both sides of each stacker.

FIG. 13 is an enlarged side elevation schematic similar to FIG. 11 viewed from 13-13 of FIG. 12, both stackers illustrating platform elevating and lowering means, upper and lower platform positions, and the overhead vacuum belt for transport of segments forward to the next stacker for alternating stack completion.

FIG. 14 is a schematic end view from 14-14 of FIG. 13 (platform drive omitted) illustrating the space between the top of the lowering platform and the rail supported elevation of the completed stack for insertion of stack removal arms and transfer to space adjacent the stacker on both sides. Upper center trim removal vacuum belt and segment vacuum belts are shown (also shown in FIGS. 13, 18)

FIG. 15 is a diagrammatic plan view of a web for making four segments from two adjacent slit webs illustrating a pair of water jet cutters on each slit web to generate a pair of parabolic curves on each web which intersect a longitudinal axis of symmetry at segment ends. Jet cutters for trim slits shown.

FIG. 16 is a simplified side elevation viewed along 16-16 of FIG. 15 illustrating a spaced pair of cutters on both parallel transverse cutter paths.

FIG. 17 is a diagrammatic plan view illustrating segment pairs each having three parabolic shaped surfaces being produced from a plurality of eight parallel webs slit from the full width web. Eight jet cutters on each transverse path cut sixteen oscillating parabolic curves to form sixteen opposing segments after intersecting at segment ends. Groups of four segments are stacked and ejected from each side. Each group of four segments requires two stackers in series for alternate stacking, Eight stackers for four segment groups are shown without space for platform elevating means.

FIG. 18. Is a simplified side elevation viewed from 18-18 of FIG. 17 illustrating the downward position of stacker stop plates to bypass stackers when producing only corrugated paperboard segments for cartons.

### DETAILED DESCRIPTION OF THE INVENTION

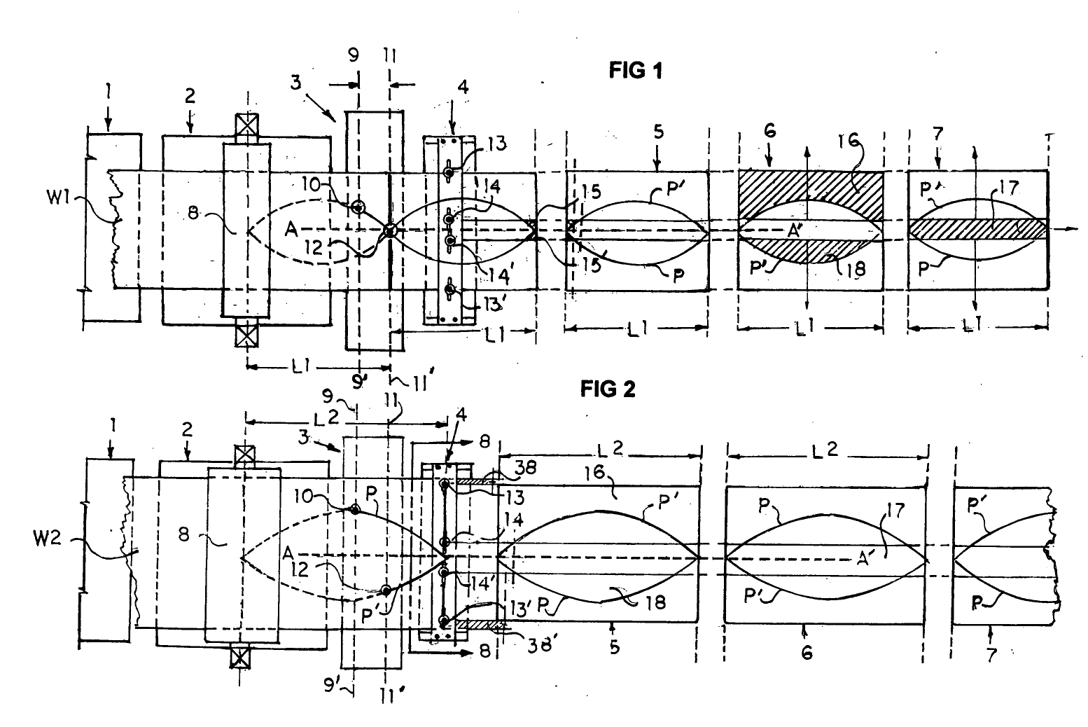

In FIG. 1, sections 1-7 of the apparatus include the corrugating machine dryer 1, and corrugating machine cutoff section 2 with adjustable length cutoff rolls 8 (lower roll under web W 1 not shown). Roll 8 is shown at the instant of cuttingweb W1 transversely to form a segment length L 1.

Water jet cutting section 3 for parabolic cuts includes a first transversely movable jet cutter 10 for oscillating movement about axis of symmetry A-A′ along path 9-9′ to generate a parabolic cut line P above and below the axis.

Section 3 includes a second transversely movable water jet cutter 12 for oscillating movement to generate a duplicate mirror image parabolic cut line P′.

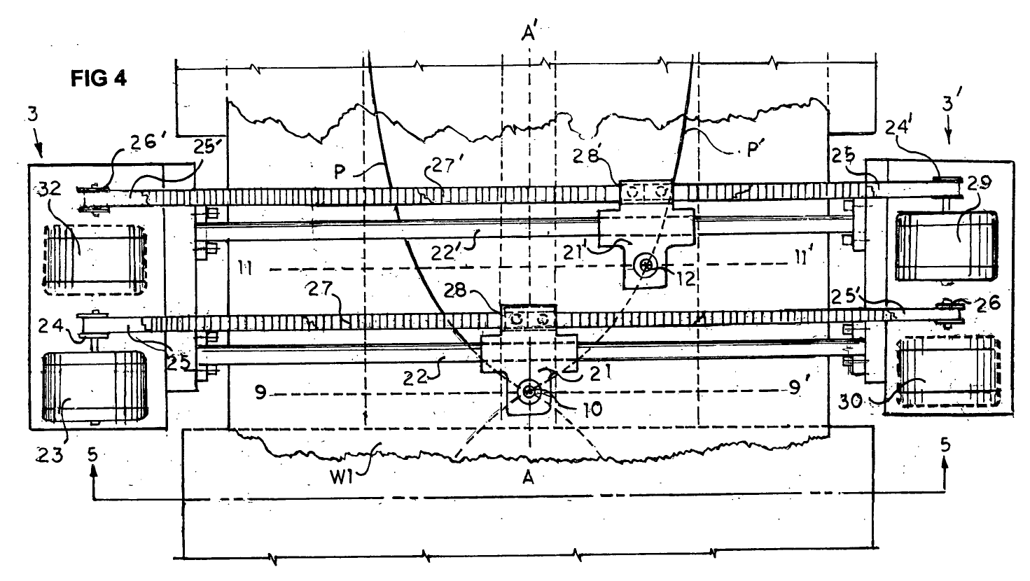

Cutters 10 and 12 are supported by holders 21, 21′ on spaced rails 22, 22′ (shown in FIG. 4) and connected to belt systems driven by programmable servo motors with algorithm software for parabolic curves of different shapes and focus points.

Cut lines P, P′ intersect at segment ends a distance L 1 apart. The solar aperture of egment 16 is equal to segment length L 1 minus the lands at each end of the segment after removal of trim pieces 15, 15′ created by water jet slitters 14, 14′ in section 4 as they cut through ends of cuts P, P′.

Parabolic cut line P is spaced from the axis of symmetry A-A′ by plus values of the formula in one segment followed by minus values in a successive segment to define the oscillating shape above and below the axis. A similar mirror image parabolic cut line P′ is generated by the other jet cutter and the program for instantaneous values of the cutter position on the P′ curve is modified by the axial distance between cutters.

In section 4 of FIG. 1 center trim jet cutters 14, 14′ and edge cutters 13, 13 are mounted on a stationary cross support over the moving web.

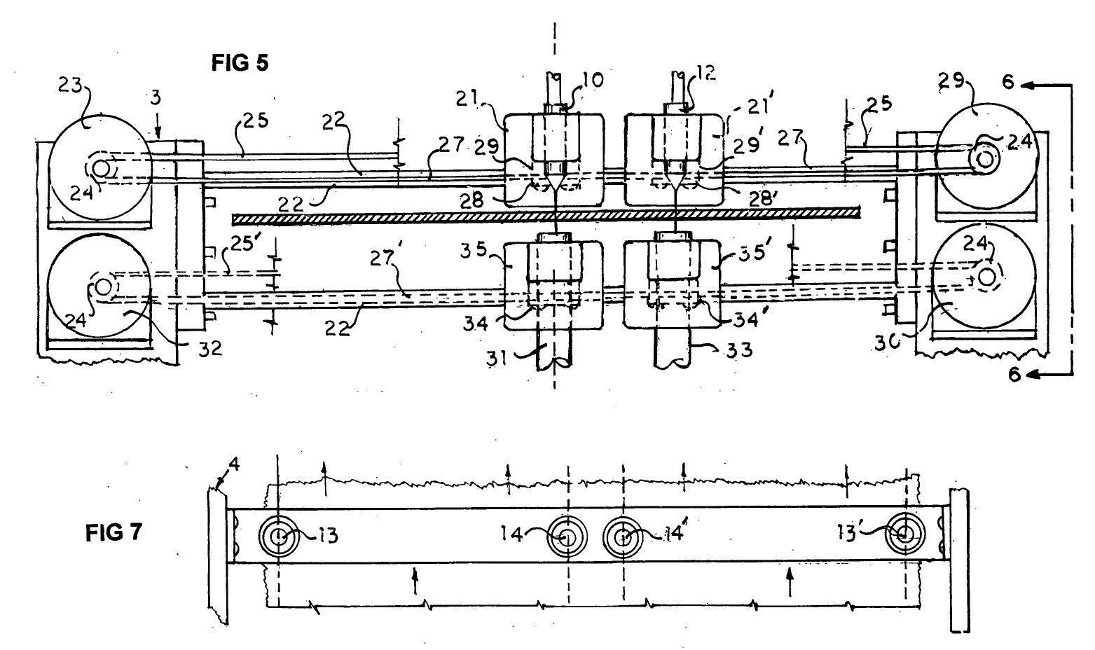

In FIG. 1, jet cutters in sections 3 and 4 are shown above the web. Jet stream receivers 31,33 for each cutter are shown below the web in FIGS. 5, 6.

In FIG. 1, parabolic segment 16, center scrap portion 17, and an intermediate parabolic portion 18 adjacent the center scrap cut line are crosshatched for clarity of shape.

In FIG. 1, transfer/diverter section 5 includes separate hinged plates for transfer of the center piece to a scrap belt and the two outside segments for transfer by two side vacuum belts 42′ to stacker 6, and when the stack is completed, sliding advance to stacker 7.

In FIG. 2, web W 2 is cut into segment lengths L 2. parabolic cuts P, P′ intersect at the rotary cutoff unit 2′ under roll 8′.

In FIG. 2, jet cutter section 3 is the same as in FIGS. 1, 2. The values to generate the specific parabolic curves P, P′ are digitally entered into the software algorithm to position cutters 10, 12 on the programmed curve P, P′ which intersect on the axis of symmetry A-A′ at segment ends. The sum of axial distance from cutoff 8 to the first cutter 10, space between cutters 10, 12 and the distance from 12 to the opposite segment end equals L 2 as shown.

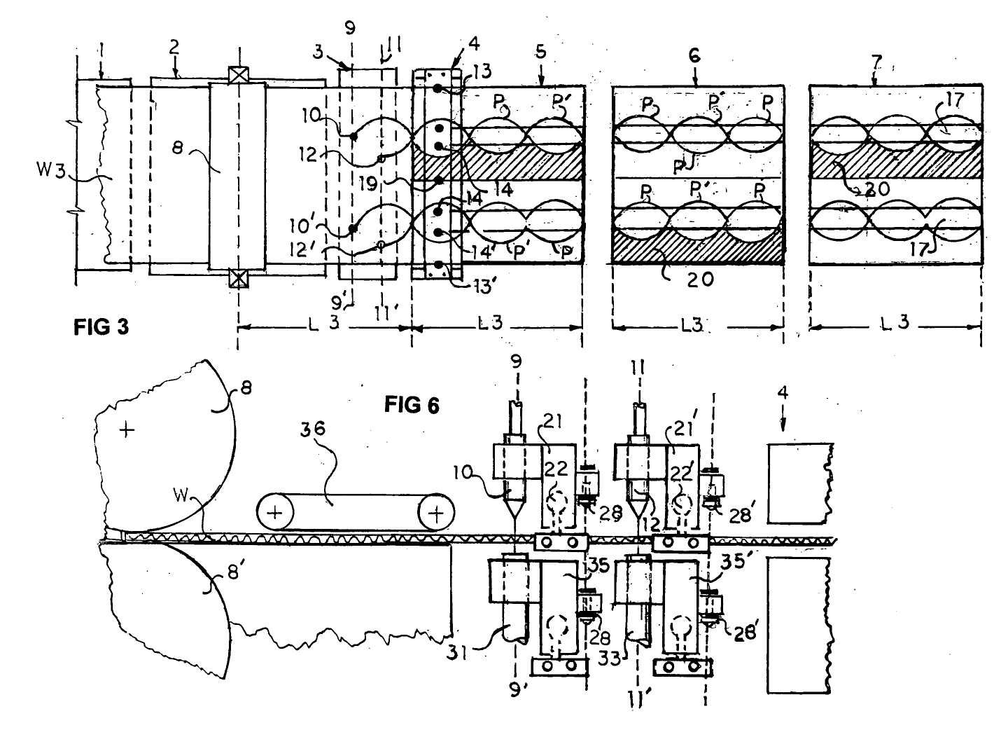

In FIG. 3, web W 3 is slit in half by stationary jet cutters 14′ in section 4.

In FIG. 3 two spaced reversing jet cutters on path 9-9′ cut three curves P, and two spaced jet cutters on path 11-11′ cut 3 similar intersecting parabolic curves P′ in each of the juxtaposed half web segments 20 to produce segment pairs of length L 3 in each half web.

The contour of the parabolas and the number per segment changes for different applications and determine segment length L 3. For solar hot water collectors a plurality of three parabolic curves per segment is like U.S. Pat. No. 6, 892,724. Solar trough concentrating collectors for high temperatures have one parabola per segment as in FIGS. 1 and 2

For wider webs, mulltiple upper cutters and lower receivers are connected to belt drive systems along transverse paths 9 and 11. Multiple slit webs, curves, and segments are shown in FIG. 17.

In FIG. 4, components relating to cutter 10 on path 9-9 above the web cut curve P and include servo motor 23, drive pulley 24, upper belt portion 25, lower belt 27, and holder 21 supported by cross support 22.

Components for cutter 12 on path 11-11 above the web cut curve P′ and include servo motor 29, drive pulley 24′, upper belt portion 25′, lower belt 27′, and holder 21; supported by cross support 22′.

Upper belts 25, 25′ are cutaway to expose gear teeth of lower belts 27, 27′ for connection to holders 21, 21′ as at 28, 28′.

Motor support frames 3, motors 23, 29, and other belt drive components extend beyond the outside edges of web W 1. Oscillating movement of cutters reverses between nadirs of the opposing parabolic curves.

In FIG. 4, the locations of receiver servo drive motors 30, 32 are shown dashed (other components obscured).Duplicate drives components (see FIGS. 5, 6) are used below the web for moving jet stream receivers in unison with the cutters 10, 12.

In FIG. 5, portions of the top belt run 25, 25′ are cutaway as in FIG. 4. Bottom belt runs 27, 27′ are attached to a rear extension of holders 21, 21′

In FIG. 6, corrugator cutoff rolls 8, 8′ cut web W to a selected length L. Butted segments are advanced by pressure belt 36 as they slide in butted relationship for web cutting by jet cutters 10, 12, and longitudinal slitters 13, 14. Subsequently speed up belts 42, 42′ create a gap between segments to provide space between segments and time for up or down movement of diverter plates as segments are directed toward stacker path 6 or stacker path 7.

In FIG. 7, cross support member 37 is attached to side frames of slitting section 4 to support edge slitters 13,13′ and center trim slitters 14, 14′.

Slit cuts are made after the parabolic cuts P and P′ are completed upstream.

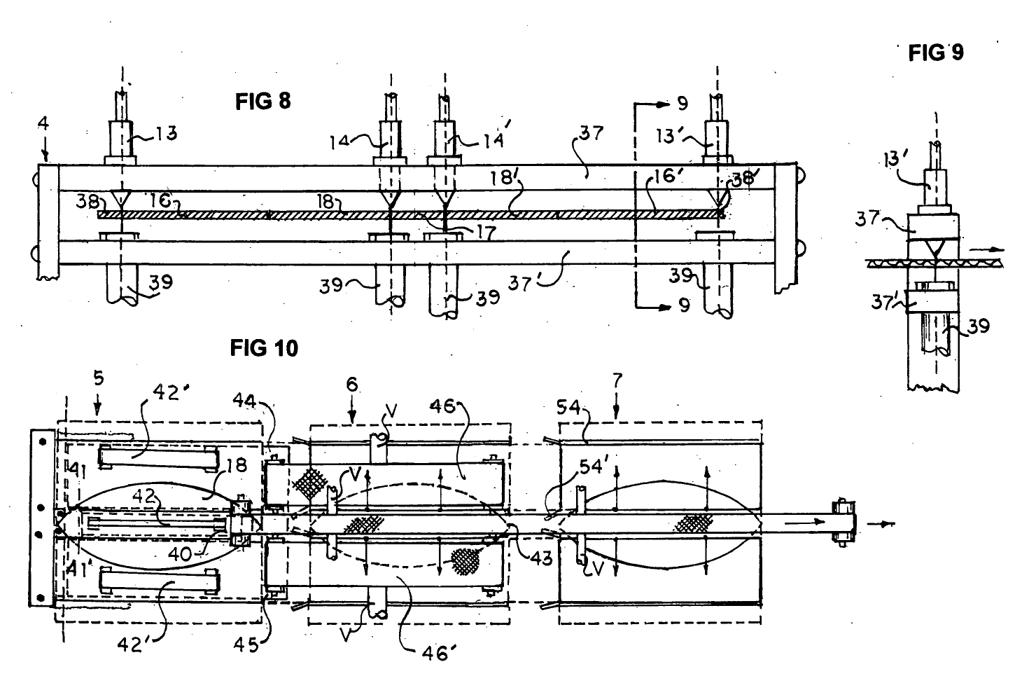

In FIG. 8, cuts from slitters 14, 14 define center scrap piece 17 (shown in FIG. 1) and create opposing end segments 15,15′ as top portions of parabolas are cut to create lands at segment ends (see FIG. 1 exiting section 4)

In FIG. 8, trim cutters 13,13′ removes deckle or excess web 38, 38′ (shown In FIG. 2) to define the bottom linear edge of segment 16.

In FIG. 9, jet cutters 13, 13′ are mounted on cross member 37. Lower cross member 37′ supports jet stream receivers 39.

In FIG. 10, frame outline for sections 5, 6, 7 are shown dashed.

Segments entering section 5 are butted and held against plate 40 by center speed up belt 42 and side belts 42′. Central plate 40 pivots about axis 41-41′, is inclined and directs center scrap for transfer beyond the end of the machine by suspended transfer under vacuum belt 43.

In FIG. 10, parabolic portions 18, 18′ adjacent center scrap piece 17 and the outer segments 16, 16′ advance along outer side paths over plates 44, 45 and under two speed up belts 42′ create a gap between successive units. The gap permits time for plates 44, 45 to pivot from one stacker path to the other, and portions 18, 16 are advanced as a unitary segment into engagement by side vacuum transfer belts 46, 46′.

In FIG. 10, belts 46, 46′ terminate over first stacker 6 and advance by sliding forward to platform 51 in stacker 7. For producing parabolic segments or standard corrugated segments, duplicate vacuum transfer belts 46, 46′ are added to stacker 7 to bypass all stackers and advance the uncut corrugated segment past the end of the last stacker for normal handling.

After segment separation and transfer to vacuum belts and stackers, digital advance steps or position sensors (not shown) determine when a selected stack count is reached, other devices are activated to complete the stacking process including actuators for diverter plates 44, 45, stops 48, 49, vacuum for belts 46, 46′, elevator platform positions 51, 52′ or 51′,52 and stack removal arms 63, 63′.

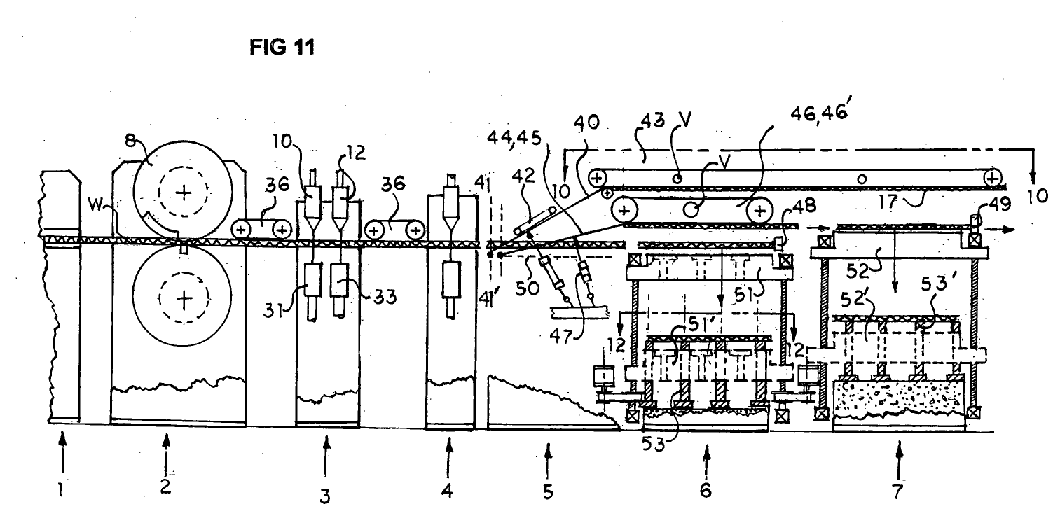

In FIG. 11, stop plates 48 is in the up position when stacker 6 is in use and plate 49 is up to stop segments fdor stacker 7. Both stops are in the down position when the machine runs only standard corrugated segments for Containers.

In FIG. 11, stacker platform 51 in stacker 6 is shown solid at the uppermost elevation for receiving the first segment of a new stack. At this instant, stacker 7 is discharging a previously completed stack and is subsequently raised to position 52 by the time stacker 6 completes a stack.

As segments are added to stacker 6, platform 51 is lowered and successive segments are placed on top of the preceding segment until stack completion when the segment stream is transferred to stacker 7.

Platform 51 of 6 continues to lower until the stack rests on top of fixed rails 53. Platform 51 continues to lower until reaching position 51. With adjacent stacks on rails 53 and platform 51 at position 51′, stack removal arms 63, 63′ are inserted in space 64 from both sides, raised, and withdrawn to deliver stacks on both sides at positions 67, 67′.(shown in FIG. 14)

The platform is moved upward from 51′ to position 51 while stacker 7 is stacking to deliver the next stack.

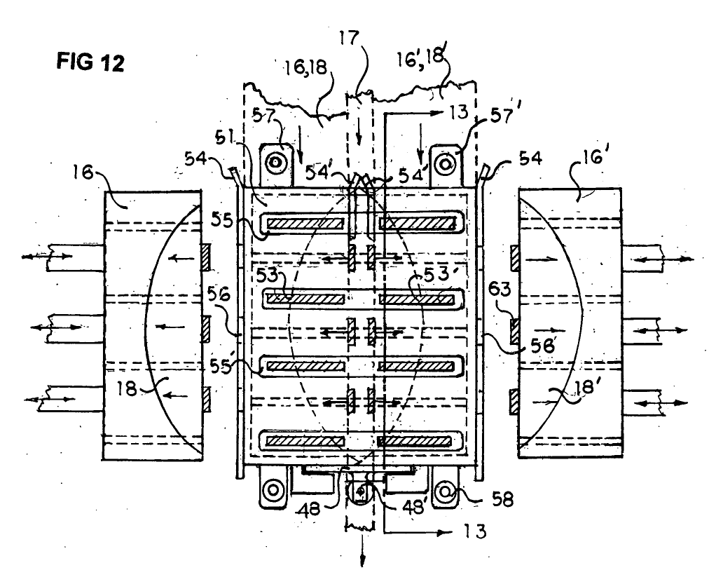

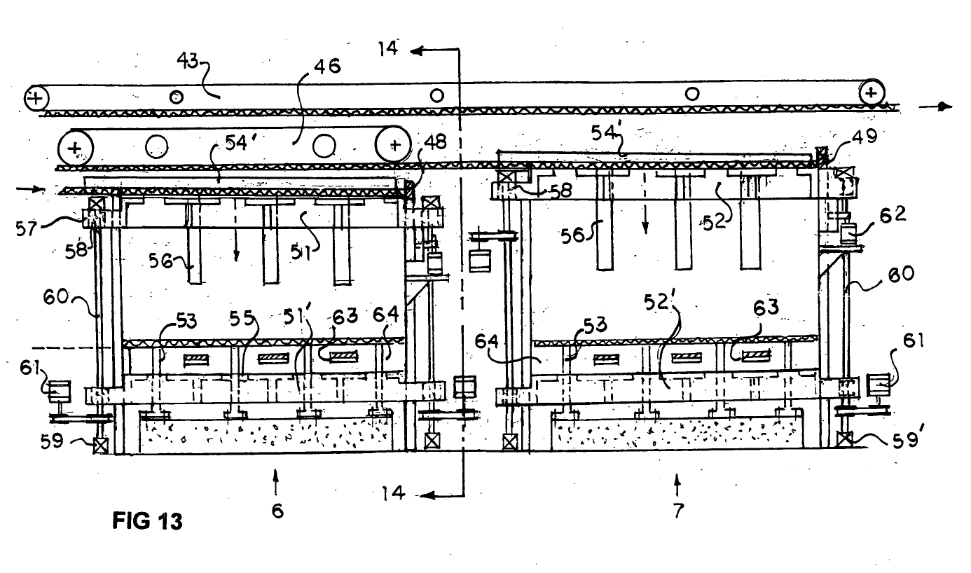

Details of the platform are described in FIG. 12, and the platform elevating drive in FIG. 13.

In FIG. 12, web portions 16,18 and 16′,18′ (shown in FIG. 1) are advanced together to platforms 51, 52. Outer edge side guides 54 and inner side guides 54′ contain the components in rectangular unity as they advance to stops 48 49.

Segment end guides (not shown for clarity) extend downward a limited distance at the infeed end to allow component containment between stops 48, end guides (not shown) and downward extending side guides 56.

In FIG. 12, platforms 51, 52 are duplicates.

Platforms 51, 52 have spaced apertures 55 aligned above support rails 53, 53′ which support completed stacks when platforms 51, 52 are lowered below rails 53, 53′ (shown crosshatched).

In FIG. 12, platforms have extended arms 57 contain threaded inserts 58 for cooperation with rotating threaded screw 60.

In FIG. 13, platforms are raised/lowered by screw 60 held in end bearings 59 as screw 60 is rotated by a motor and pulley drive belt system 61.

In FIG. 13 vacuum belt 43 transports scrap piece 17. Belts 46, 46′ each advance cut portions 16, 18 and 16′, 18′ above stacker 6. Actuator 62 raises and lowers stop plate 48 with attached extension 48′ (see FIG. 14).

In FIG. 14, stack removal arms arms 63, 63′ inserted in space 64 move up to lift completed stacks C, C′ from support rails 53, 53′ for transfer to stack transfer positions 67, 67′.

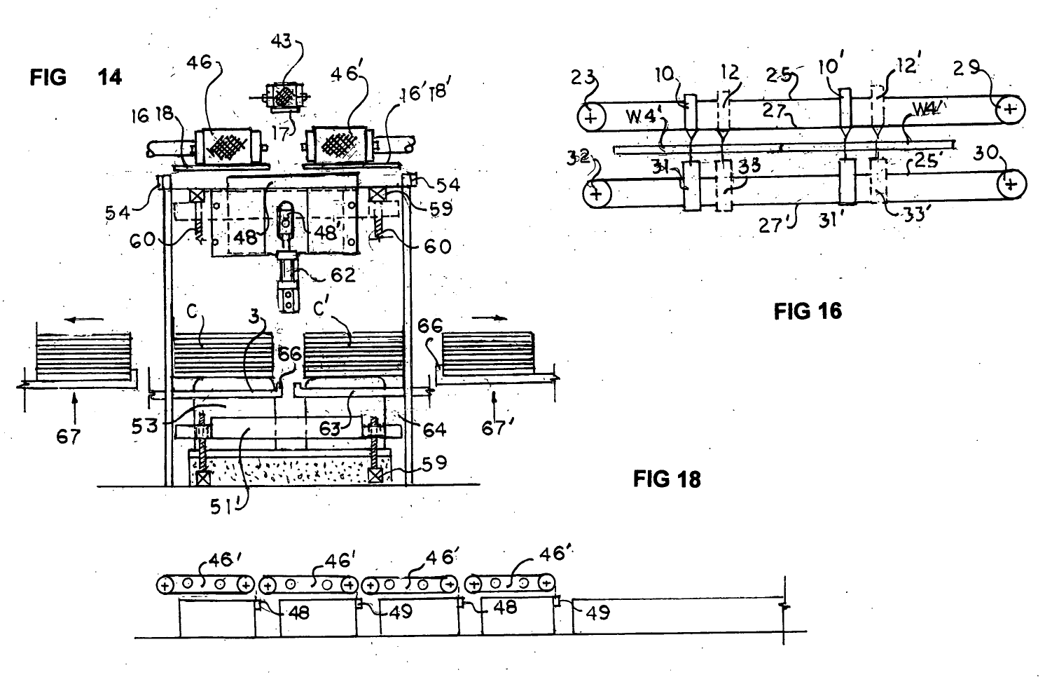

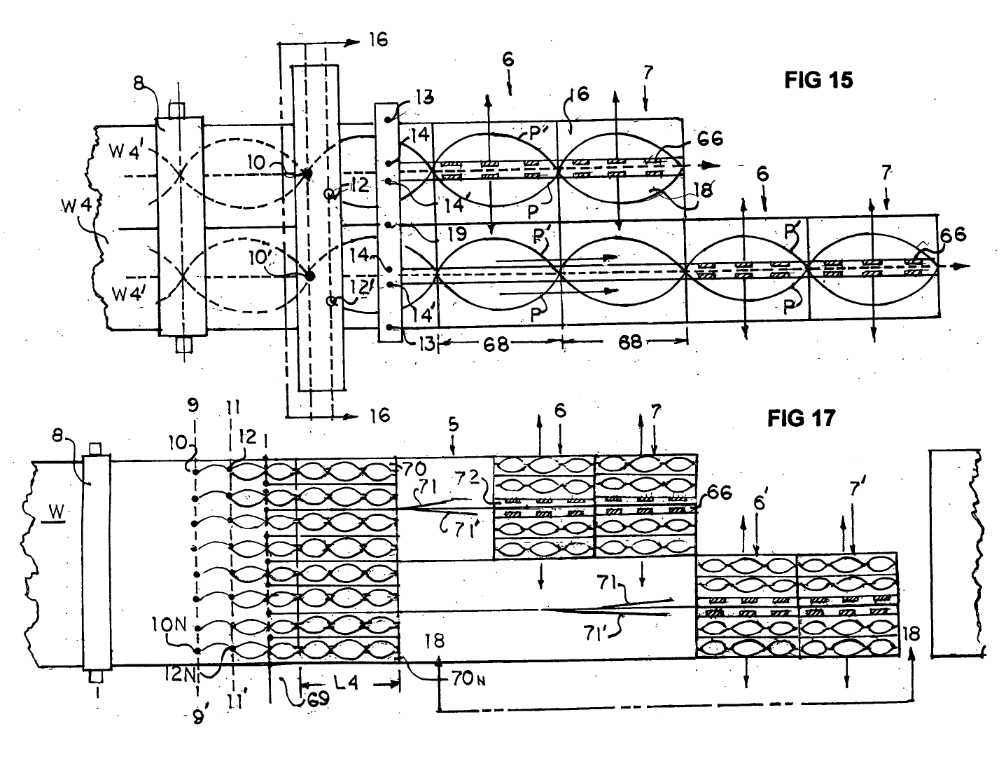

In FIG. 15, web W 4 is slit in half by jet slitter 19 of section 4 to form ]parallel webs, each with double parabolic cuts P, P′ to form segments stacks wiith 16 and parabolic portions 18.

Section 3 is as described above except another jet cutter assembly is added to each belt in path 9-9 and 11-11.

In FIG. 15, using two cutters (receivers not shown) on each path produces the intersecting parabolas in each half web and a total of four segment stacks that are alternately stacked as two groups in successive stackers. The second pair of stackers are moved downstream across blank spaces 68, 68′ to avoid stack discharge interference with the first pair.

In FIG. 16, second jet cutters 10′, 12′ are added to the drive belt for 10, 12. Belt drives 25′, 27′ show receivers 31, 31′ on path 9-9 and 33, 33′ on path 11-11′.

In FIG. 17, a plurality of jet cutters 10-10n are attached along path 9-9 and 12-12n along path 11-11. Multiple intersecting curves and segments are produced.

In this instance, curves P, P′ intersect at parabolic length 69 and each segment length L 4 includes three parabolic repeats per segment. Since the intersections define three separate center strip pieces, these portions are rejected in a space below the web line before reaching the diverter/transfer section 5

In FIG. 17, as remaining portions 70-70n without intermediate pieces are advanced rails 71, 71′ urge segment groups toward outside side guides 54 (center of FIG. 12) thus creating gap 72 for insertion of stack removal arms 67.

In FIG. 18, two tandem arranged stackers 6, 7 include parallel vacuum transfer belts 46, 46′ to advance two groups of web portions 16, 18 forward. segment stops 48, 49 are selectively actuated when parabolic segments are being made.

When stacker 6 is operating, vacuum to belts 46, 46′ is switched off and segment stop 48 is up. When stacker 7 is operating ,vacuum to 46, 46′ belts is on, stop 48 is down and stop 49 is up.

For running only standard corrugated board without jet cuts all upper vacuum belts are operative and all stops are activated to the downward position.

The present invention may be embodied in other specific forms without departing from the spirit or special attributes and it is therefore not restrictive, reference being made to the appended claims to indicate the scope of the invention.

### REFERENCE NUMBERS

W web: corrugated material
1 dryer section
2 cutoff section
3 parabola cutting section
4 linear sllitting section
5 diverter section
6 first stacker section
7 second stacker section
8 cutoff rolls
9-9; first cutting path
10 first water jet cutter
11-11 second cutting path
12 second water jet cutter
P first parabolic cut line from 10
P′ second para/cut line from 12
A-A′ axis of symmetry (longitudinal)
13-13 edge water jet slitters 14
14 intermediate w.j. slitters
L segment length
15 trim pieces at intersection
16 para. web portion
17 center scrap piece
18 parabolic segment
19 water jet web half slit
20 segment w/multiple parabolas
21 cutter and receiver holders
22 cross rails/supports
23 servo motor: cutter 10
24 drive pulley: cutter 10
25 drive belt: top-cutter 10
26 idler pulley
27 drive belt: lower (teeth show)
28 belt attachment to cutter holders
29 servo motor for cutter 12
30 servo motor for receiver 31
31 receiver for cutter 10
32 servo motor for receiver 33
33 receiver for cutter 12
34 fixed belt conn.to holder 35
35 holder for receiver under web
36 hold down bwlt: ex cutoff section on removal arms
37 cross support fot slitters 13, 14
38 deckle or trim excess web
39 fixed jet receivers for slitters
40 inclined plate: for scrap
41 hinge line for 40
42 speed up belt: center scrap
42′ speedup belts: side webs
43 upper scrap vacuum belt
44 first plate: left web portions
45 second plate: right. web”
46 first vacuum xfer belt-L.H.
46′ 2^{nd} vacuum xfer belt-R.H.
47 air cyl fo diverter plate
48 stop plate: stacker 6
49 stop plate: stacker 7
48′ Extension for pl. 48
50 level posit: parabolic or corr.
51 # 6 platform-upper posit
51′ # 6 platform-lower”
52 # 7 platform-upper posit
52′ # 7 platform-lowerposit
53 stack support rails
54 segment side guides
55 platform apertures
56 vertical segment side guides
57 platform extension arms
58 threaded inserts in arms 57
59 bearings for screw=both ends
60 platform elevating drive
61 servo motor for drive 60
62 actuator for stop plates
63 stack removal arms
64 space fpr arms 63
65 external stack support rails
C completed stack
66 vertical lip on arm 63
67 stack tramsfer positions
68 floor space for stack removal
69 parabolic aperture length
70 segments with 3 parabolas
71 diverter rails for groups
72 space between stacks for lips on removal arms

Having thus described the invention, what is claimed as new and desired to protect by Letters Patent are the following:

1. Apparatus for making parabolic support segments for solar concentrating trough collectors from a web of advancing corregated material comprising:
means to sever segments from said advancing web,
water jet means to cut a pair of oscillating parabolic cut lines about a longitudinal axis of symmetry, intersecting said axis at segment ends,
means to water jet cut a plurality of slits parallel to said longitudinal axis of symmetry,
means to speed up, advance and divert selected web portions for advancement along a plurality of paths,
vacuum belt means to advance a slit central portion of web segments along a first path ending beyond the end of the apparatus
vacuum belt means to advance remaining web portions on both sides of said central portion along a second selected path,
means to stack said remaining side web portions on the first of tandem arranged stackers, each having a vertically movable platform having apertures,
means to lower said platform with said apertures below fixed stack support rails protruding through the apertures to deposit stacks of the side web portions on said rails,
means to divert and vacuum transfer a selected plurality of remaining web portions for stacking on a second stacker platform while said first completed stack is being discharged from said first stacker.

2. The apparatus of claim 1 wherein said means to sever segments is the cutoff section of a corrugating machine, said segment cuts being transverse of the web axis and forming butted segments for advancement.

3. The apparatus of claim 1 wherein means to cut a pair of parabolic cut lines includes programmable drive motors and jet cutters to intersect said parabolic cut lines at ends of a segment, each of said parabolic cut lines defined by plus and minus values for oscillating about an axis of symmetry with frequency of parabolic oscillation being a function of web speed along said axis.

4. The apparatus of claim 3 wherein said means to cut a pair of Intersecting parabolic cut lines in a moving web includes a water jet cutter attached to a belt moving in a transverse first path driven by a programmable and reversible servo motor cooperating with a second jet cutter attached to a similar belt drive system for reversible movement along a transverse second path that intersects said first parabolic cut line on said axis at segment ends.

5. The apparatus of claim 3 wherein said first and second paths of transverse movement are parallel, spaced, and contain jet cutters attached to belts driven by separate servo motors.

6. The apparatus of claim 3 wherein said cutters mounted above a moving web cooperate with jet stream receivers mountes below the web and attached to a similar belt drive system and programmed to move in synchronism with said upper jet cutter.

7. The apparatus of claim 1 wherein the parabolic cut lines are programmed by different values in the parabolic formulae to define the parabolic contour, aperture length, and movement of cutters along the axis of symmetry as a function of web speed , and transverse movement of cutters as a function of plus and minus values of the cut lines perpendicular to and measured from the axis for selected values in the parabolic formula.

8. The apparatus of claim 1 wherein selected water jet cutters define slits along selected linear edges of segments and intermediate water jet cutters define slits for central scrap pieces and parabolic web portions.

9. The apparatus of claim 1 wherein means to advance cut web portions includes speed up belts in contact with the upper surface of web portions for spaced advancement on a selected diverter plate.

10. The apparatus of claim 1 wherein means to divert selected web portions include a central plate and speed up belt pivoted to advance central web portions for transfer to an extended overhead vacuum transfer belt and a pair of adjacent pivoted plates and speedup belts to advance adjacent web portions to a pair of vacuum transfer belts and overhead transport beyond the first of two tandem arranged stackers for deposit and stacking on said second stacker.

11. The apparatus of claim 1 including vacuum shutoff means for the overhead transport belts and upward extended segment stop plate for stacking Segments and web portions on the first of two tandem arranged stackers.

12. The apparatus of claim 11 wherein said tandem arranged stackers include cycling means to alternately stack segments on one stacker while the other is discharging a completed stack.

13. The apparatus of claim 1 wherein said means to stack web segment portions includes a vertically movable platform with spaced elongated apertures and platform extension arms with fixed threaded sleeves cooperating with a threaded vertical rods rotated by servo motor to raise or lower said platform a selected amount per revolution.

14. The apparatus of claim 1 wherein fixed stack support rails pass through and extend above said lowering platform to support two spaced completed stacks on said rails and wherein vertical space is created between said supported stacks and the platform further including arms inserted into said spaces to remove and discharge stacks from both sides of the stacker.

15. The apparatus of claim 3 wherein the frequency of oscillation of said pair of water jet cutters on said parallel paths is increased to provide a plurality of parabolic curves and surfaces between segment ends.

16. The apparatus of claim 1 wherein tandem arranged stackers are spaced and located downstream from another tandem arranged group of stackers to stack and discharge stacks from a different plurality of adjacent webs

17. The apparatus of claim 1 wherein segment stop plates of each stacker in a plurality of stackers is actuated downward for passage of standard corrugated segments without jet cuts

18. The apparatus of claim 1 wherein tandem stackers are spaced apart and drive means for platform elevation, segment stop plate activators and vertical stacking guides occupy portions of said space.

19. A method for making parabolic support segments from a moving web of corrugated material including the steps of;
cutting segments from said web,
water jet cutting a pair of oscillating parabolic cut lines about a longitudinal axis of symmetry,
water jet cutting a plurality of slit lines parallell to said axis,
transfer and diverting selected web portions for advancement along a plurality of paths,
advancing a central slit web portion along a first overhead path,
advancing cut parabolic and side web portions along a plurality of second paths,
stacking said web portions on the first of two tandem stackers, each with a movable platform having apertures,
Lowering said platform and apertures below said fixed stack support rails that extend through said apertures,
supporting a completed stack on said rails and diverting a second series of segments for stacking on the second of two tandem stackers while the first completed stack is being discharged.
stacking segments alternately and sequentially on said tandem stackers.
